(19) United States
(12) Patent Application Publication
(10) Pub. No.: US 2019/0196458 A1
(43) Pub. Date: Jun. 27, 2019

(54) METHOD FOR SELECTING LEADING ASSOCIATED PARAMETER AND METHOD FOR COMBINING CRITICAL PARAMETER AND LEADING ASSOCIATED PARAMETER FOR EQUIPMENT PROGNOSTICS AND HEALTH MANAGEMENT

(71) Applicant: Marketech International Corp., Taipei City (TW)

(72) Inventors: Chien-Ming Martin WEI, Taipei City (TW); Yu-Jen WANG, Taipei City (TW); Hao-Yen CHANG, Hsinchu City (TW)

(21) Appl. No.: 16/001,520

(22) Filed: Jun. 6, 2018

(30) Foreign Application Priority Data
Dec. 25, 2017 (TW) 106145522

(51) Int. Cl. G05B 23/02; G06N 7/00; G06N 5/02; G06Q 50/04

(52) U.S. Cl. CPC G05B 23/024; G06Q 50/04; G06N 5/022; G06N 7/005

(57) ABSTRACT

The present invention provides a method for selecting a leading associated parameter. Selection is performed on data collected by a sensor, and the data is divided into a critical parameter set and another feature parameter set. From the feature parameter set, one parameter that affects beforehand in time the critical parameter is identified as a leading associated parameter. The present invention further uses the critical parameter set and the leading associated parameter to construct an equipment prognostic and health management model that effectively enhances an early warning capability.

### FIELD OF THE INVENTION

The present invention relates a method for equipment prognostics and health management (PHM), and more particularly, to a method for combining a critical parameter (CP) and a leading associated parameter (LAP) for PHM so as to enhance an equipment maintenance prediction capability.

### BACKGROUND OF THE INVENTION

In the manufacturing industry, in order to achieve the demand for stable quality of mass production, strict monitoring and observation are conducted with respect to critical process parameters. The so-called “critical process parameter” refers to a factor most correlated with equipment failures. For example, when an abnormality such as bearing damage and short circuitry occurs in equipment, it is frequent that the temperature of the equipment rises abnormally. Thus, for equipment such as a motor, “temperature” is considered a critical process parameter.

These “critical process parameters” serve as an index for equipment prognostics and health management (PHM). To enhance the accuracy of PHM, there are numerous improvements proposed in the prior art. For example, the U.S. Patent Application No. 20160350671 discloses a dynamically updated predictive modeling of systems and processes. The above application is characterized that, on the basis of data acquired by a plurality of sensors, updating is dynamically performed in response to dynamic changes in the environment or monitored data in an operation period to generate a new probability model, and a probability model replaced by the subsequently generated probability model can be removed from currently used probability models. More specifically, in the above application, after a system or a process is monitored by a plurality of sensors for a period of time and source data is collected, a computer creates, based on the source data, feature data context values including at least one a contextual relationship. The feature data context values are later independently used in multiple statistical models, and a correlation between the feature data in each feature data context value and each of the applied statistical models is analyzed, wherein each correlation generates a statistical model associated with the likelihood of occurrence of an operational outcome of interest during operation of a system, a hardware device, or a machine. The probability model is validated according to the data selected from source data; alternatively, after combining multiple probability models, a supermodel is generated and the supermodel is then validated according to the data selected from the source data. Eventually, based on results of the validation result, at least one probability model is selected for the prediction of the operational outcome of interest.

However, there are damages that are too minute to be detectable by a device, and a failure has often already taken place when an abnormality is detected. In addition to spending maintenance costs of the equipment, products currently being manufactured may also be impaired. During equipment maintenance and repair, production line suspension caused may affect the delivery date of products, and such loss is usually more sizable than the maintenance and repair costs of the equipment. Therefore, if an equipment abnormality can be beforehand detected, costs due to equipment failures can be significantly reduced.

### SUMMARY OF THE INVENTION

It is a primary object of the present invention to solve an issue of a conventional equipment PHM system, in which only a factor most correlated with equipment failures is focused and a monitored factor is too unique and simple, resulting in an inadequate early warning capability of a PHM system.

To achieve the above object, a method for selecting a leading associated parameter (LAP) is provided according to an embodiment of the present invention. The method includes steps of:

(S11) collecting a plurality of sets of data by at least one sensor, and performing selection on the data by using a feature extraction algorithm to form a feature database;

(S12) dividing data in the feature database into a critical parameter (CP) set including at least one critical parameter and a feature parameter set including parameters other than the critical parameter;

(S13) identifying, by using a causality algorithm, a plurality of associated parameters leading the critical parameter from the feature parameter set to form an associated parameter candidate set; and

(S14) selecting, from the associated parameter candidate set, one associated parameter that produces earliest in time a reaction to a change of the critical parameter as the leading associated parameter.

A method for equipment PHM is provided according to another embodiment of the present invention. The method includes steps of:

(S21) collecting a plurality of sets of data by at least one sensor, and performing selection on the data by using a feature extraction algorithm to form a feature database;

(S22) identifying a leading associated parameter that produces beforehand a reaction to a change in a critical parameter from the feature database; and

(S23) constructing an equipment prognostic and health management model on the basis of the critical parameter and the leading associated parameter.

In the method for selecting a leading associated parameter provided by the present invention, the leading associated parameter is, from all associated parameters, a factor before the critical parameter and reacting earliest in time to the critical parameter. Thus, by using the combination of the critical parameter and the leading associated parameter for equipment prognostic and health management model, the present invention achieves better effectiveness in providing early warning compared to the prior art that monitors only a critical parameter most correlated with a failure.

### BRIEF DESCRIPTION OF THE DRAWINGS

FIG. 1 is a flowchart of a method for selecting a leading associated parameter according to an embodiment of the present invention;

FIG. 2 is a flowchart of a method combining a critical parameter and a leading associated parameter for equipment PHM according to an embodiment of the present invention; and

FIG. 3 is a data difference level of a critical parameter and a leading associated parameter monitored according to an embodiment of the present invention.

### DETAILED DESCRIPTION OF THE PREFERRED EMBODIMENTS

Details and technical contents of the present invention are given with the accompanying drawings below.

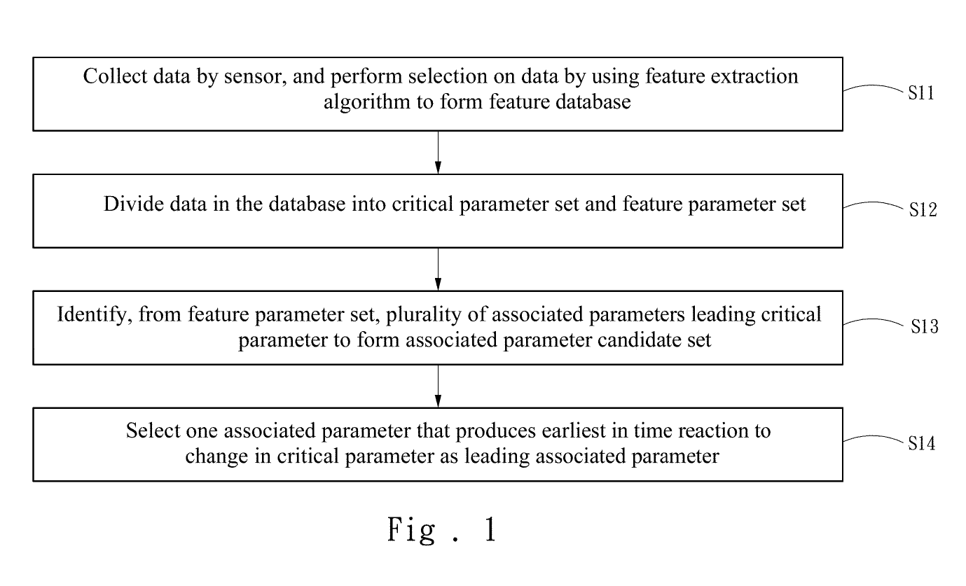

Referring to FIG. 1, according to an embodiment of the present invention, a method for selecting a leading associated parameter includes steps (S11) to (S14) below. The leading associated parameter is associated with an operation output from an operating system, a hardware device or a machine.

Along with the development of the Internet of Things (IoT), most new-model devices including an operating system, a hardware device or a machine are capable of executing a real-time data outputting function through a sensor provided therein. Accordingly, a large amount of sensor data is collected, and may be stored in, e.g., a memory including a database.

Thus, in step (S11), data pre-processing may be performed, by a processor, on the sensor data stored in the database. That is, in the sensor data, incorrect data is removed and missing data is filled, and data frequencies of the sensor data are aligned, so as to accordingly convert the sensor data to feature data that can be used by a statistical model.

Selection is performed on the feature data by using a feature extraction algorithm. In this embodiment, the feature extraction algorithm includes two parts, statistical features and compound features. The statistical features include, for example but not limited to, a maximum value, a minimum value, an average value, a variance, a kurtosis, a skewness, a median value, a range, a mode value, an initial value, an ending value, a data difference level, or any combination of the above statistical features. The compound features include a composite feature created from, for example but not limited to, a principal component analysis, an independent component analysis, a neural network, or any combination of the above models. The feature data selected by the above feature extraction algorithm is collected to form a feature database.

In step (S12), the data in the feature database is divided into two sets, which are a critical parameter set and a feature parameter set. The critical parameter set includes at least one critical parameter. Means for selecting the “critical parameter” may be comparing a selection reference on the basis of a “critical parameter” defined by a field domain expert or any conventional mathematical models (e.g., a correlation model), or may be a factor conventionally most correlated with the equipment failure. Parameters other than the critical parameter are categorized to the feature parameter set.

In step (S13), a plurality of associated parameters leading the critical parameter are identified from the feature parameter set by using a causality algorithm. In this embodiment, the selection for the associated parameters is performed by using a Granger causality test, with a process as below.

First of all, it is assumed that the critical parameter (CP) and a selected associated parameter (AP) are a stationary times series, and a null hypothesis is “the associated parameter is not a Granger cause of the critical parameter”.

Next, an autoregressive (AR) model of the critical parameter is constructed, as equation (1) below:

CPₜ=CPₜ₋₁+ . . . +CPₜ₋ₘ+errorₜ (1)

In equation (1), CPₜ represents a value of the critical parameter observed at a time point. According to an F-test, if the explanatory power of the autoregressive model is increased after adding a lag period of CPₜ, the lag period is preserved in the model. Further, in equation (1), m represents one among lag periods of the critical parameter that is tested as apparently being the earliest in time, and errorₜ represents an estimated error.

By adding the lag period of the associated parameter, a model is constructed according to equation (2) below:

CPₜ=CPₜ₋₁+ . . . +CPₜ₋ₘ+APₜ₋ₚ+APₜ₋ₚ₋₁+ . . . +AP_{t-q}+errorₜ (2)

Similarly, according to an F-test, if the explanatory power of the autoregressive model is increased after adding a lag period of the associated parameter, the lag period is preserved in the model. In equation (2), p represents one among the lag periods of the associated parameter that is tested as apparently being the earliest in time, and q represents one among the lag periods of the associated parameter that is tested as significantly being the closest in time.

If no lag periods of any associated parameter are preserved in the model, the null hypothesis of no Granger causality holds true.

If a causality exists between the associated parameter and the critical parameter, the associated parameter is incorporated into an associated parameter candidate set.

In step (S14), an F-test is performed again on all of the associated parameters in the associated parameter candidate set by using the two models (equations (3) and (4)) below, so as to determine how much earlier the associated parameter is able to produce a reaction to a change in the critical parameter. Compared to equation (4), equation (3) additionally contains data AP_{t-q} of one period. Thus, by comparing results of equation (3) and equation (4), it can be determined whether the data of the additional period is different. If so, it means that the data of the additional period is usable data.

CPₜ=CPₜ₋₁+ . . . +CPₜ₋ₘ+APₜ₋ₚ+APₜ₋₂+ . . . +AP_{t-(q-1)}+AP_{t-q}+errorₜ (3)

CPₜ=CPₜ₋₁+ . . . +CPₜ₋ₘ+APₜ₋ₚ+APₜ₋₂+ . . . +AP_{t-(q-1)}+errorₜ (4)

The associated parameter that reacts earliest in time to the change in the critical parameter is selected as a leading associated parameter.

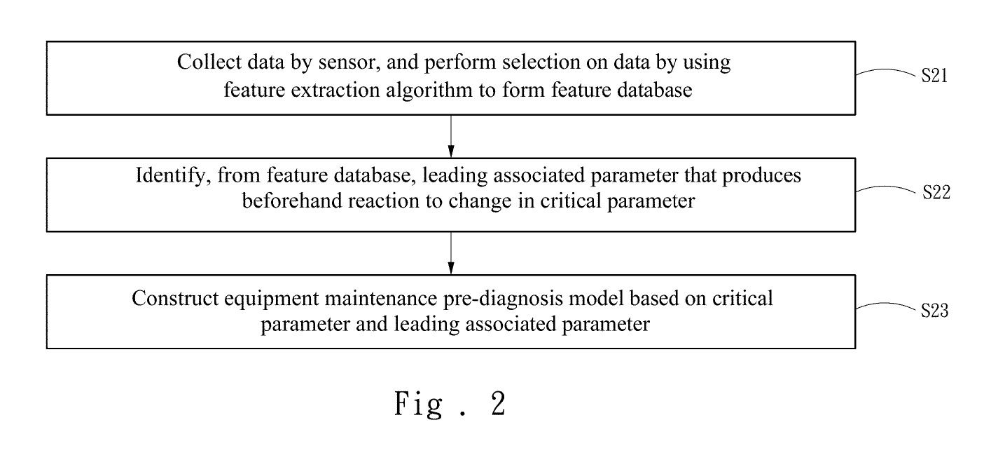

With the above method, a leading associated parameter can be selected. If the leading associated parameter is further combined with the critical parameter set, an equipment prognostic and health management model effectively enhancing an early warning capability can be constructed. Therefore, a method for equipment PHM is further provided according to an embodiment of the present invention. The equipment may be an operating system, a hardware device or a machine. Referring to FIG. 2, the method for equipment PHM includes steps of:

(S21) collecting a plurality of sets of data by at least one sensor, and performing selection on the data by using a feature extraction algorithm to form a feature database;

(S22) identifying, from the feature database, a leading associated parameter that produces beforehand a reaction to a change in a critical parameter; and

(S23) constructing an equipment prognostic and health management model based on the critical parameter and the leading associated parameter.

In step S21, the data collected by the sensor provided in the equipment needs to be converted to feature data by a first processor. Further, in one embodiment, the feature data may be stored in a memory to form a feature database. In step S22, from the feature database, a leading associated parameter that produces beforehand a reaction to a change in a critical parameter may be identified by a second processor. Details of identifying the leading associated parameter are given in the above description, and shall be omitted herein. In step S23, the equipment prognostic and health management model may be constructed by a third processor, by using, e.g., a regression model or an autoregressive integrated moving average module (ARIMA). However, a characteristic of the present invention is combining the critical parameter and the leading associated parameter that produces beforehand a reaction to a change in the critical parameter, and the model is a tool for analysis. Therefore, any appropriate model is applicable to the present invention, and the type of model applied is not limited.

It should be noted that, the first processor for identifying the critical parameter in step S21, the second processor for converting the collected data to the feature data in step S22, and the third processor for constructing the equipment prognostic and health management model in step S23 may be independent and identical processors or independent and different processors.

For better understanding, a dry pump is given as an example for further illustration.

The dry pump provides sensor data such as a booster pump speed (BP_Speed), a booster pump power (BP_Power), a master pump power (MP_Power), a master pump temperature (MP_Temperature), and nitrogen flow (N2_Flow). A user may determine a health status of the dry pump by frequently observing the temperature of the dry pump. An abnormally high temperature may be a signal of a potential failure of the dry pump, and thus “temperature” may be defined as a critical parameter. In the prior art, a failure predictive model for the dry pump is commonly constructed also based on the parameter “temperature”.

In this embodiment, the sensor data is first collected to a database, and converted to feature data by data pre-processing.

A time interval for calculating the parameter feature is designated. Within this interval, for each set of feature data, thirteen statistical features, including a maximum value, a minimum value, an average value, an median value, a range, a standard deviation, a mode value, an initial value, an ending value, a kurtosis, a skewness, and histogram distance (which may be “a difference from the histogram of first time interval” and “a difference from a histogram of previous time interval), are calculated.

In the same time interval, multiple compound features are calculated based on all of the parameters. For example, a first principal component is generated after performing a principal component analysis (PCA) and an independent component analysis (ICA), and a feature representing the time interval can be identified by using a neural network (NN), so as to generate three compound features. In this embodiment, four parameters including the booster pump speed (BP_Speed), the booster pump power (BP_Power), the master pump power (MP_Power), and nitrogen flow (N2_Flow) are used to generate 52 statistical features and three compound features, providing a total of 55 features to form a feature database.

Next, the feature that is most correlated with the critical parameter in the time interval is selected, i.e., the average value of the master pump power (MP_Power), the standard deviation of the master pump power (MP_power), and the histogram distance of the master pump power (MP_Power) from the first time interval. By using the Granger causality test, it is calculated that, in this time interval, the three features including the average value of the master pump power (MP_Power), the standard deviation of the master pump power (MP_power) and the difference of the master pump power (MP_Power) from the first time interval can lead the average values of the critical value respectively by periods of 7 hours, 1 hour and 5 hours. Thus, the average value of the associated parameter, i.e., the master pump power (MP_Power), which produces earliest in time a reaction to a change in the critical parameter is selected as the leading associated parameter (LAP).

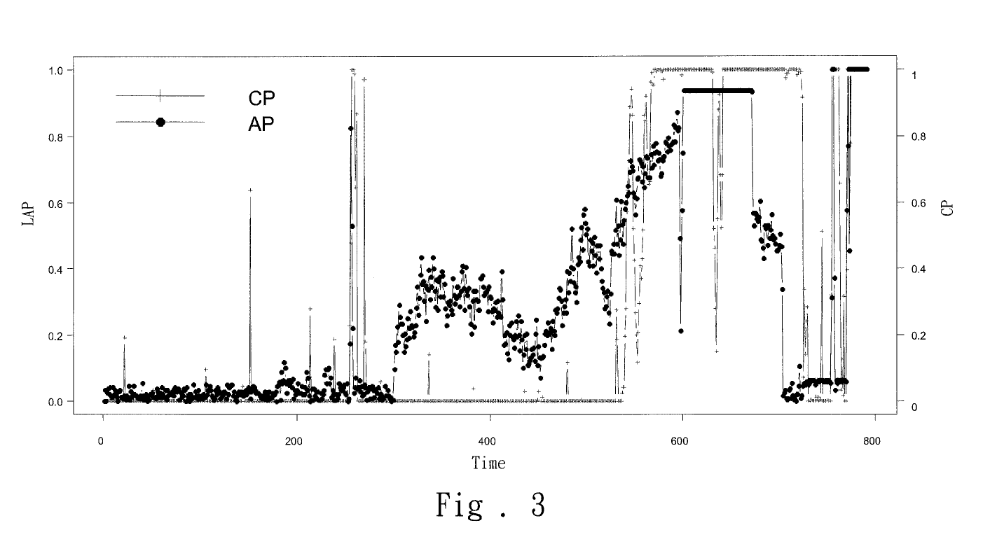

After the leading associated parameter is selected, the leading associated parameter is combined with the critical parameter to construct an equipment health indicator model. Referring to FIG. 3, using one hour as the time interval, respective histogram distance of the critical parameter and the leading associated parameter from the first hour are calculated.

It is seen from FIG. 3 that, the model constructed on the basis of the leading associated parameter is capable of discovering an abnormality in the dry pump earlier in time than the model constructed on the basis of the critical parameter. For example, when the critical parameter becomes abnormal at the 537^{th} hour of operation of the dry pump, the level rises from 0 to 0.94 at the 547^{th} hour. However, the abnormality level of the leading associated parameter starts rising gradually from 0.1 as early as the 434^{th} hour. Further, in a situation of a sudden abnormality, the leading associated parameter also reacts earlier in time than the critical parameter. For example, the abnormality level of the critical parameter rises rapidly from 0 to 1 between the 254^{th} hour to the 259^{th} hour of operation, whereas the abnormality level of the leading associated parameter starts rising rapidly from 0.02 to 0.82 between the 251^{st} hour to the 256^{th} hour.

It is demonstrated by the above embodiments that, compared to an equipment prognostic and health management model constructed solely based on the critical parameter, if the leading associated parameter is added to the construction of the model, the early warning capability of the model can be effectively enhanced.

What is claimed is:

1. A method for selecting a leading associated parameter, comprising:
collecting a plurality of sets of data by at least one sensor, and performing selection on the data by using a feature extraction algorithm to form a feature database;
dividing the data in the feature database into a critical parameter set including at least one critical parameter, and a feature parameter set including the data other than the critical parameter;
identifying, from the feature parameter set, a plurality of associated parameters leading the critical parameter by using a causality algorithm to form an associated parameter candidate set; and
selecting, from the associated parameter candidate set, one associated parameter, which produces earliest in time a reaction to a change in the critical parameter, as the leading associated parameter.

2. The method of claim 1, wherein the feature extraction algorithm is at least one selected from a group consisting of a statistical feature, a compound feature and the combination thereof.

3. The method of claim 2, wherein the statistical feature is at least one selected from a group consisting of a maximum value, a minimum value, an average value, a variance, a kurtosis, a skewness, an median value, a range, a mode value, an initial value, an ending value, a data difference level and the combination thereof.

4. The method of claim 2, wherein the compound feature is at least one selected from a principal component analysis (PCA), an independent component analysis (ICA), a neural network (NN) and the combination thereof.

5. The method of claim 1, wherein the causality algorithm is a Granger causality test.

6. A method for equipment PHM, comprising:
collecting a plurality of sets of data by at least one sensor, and performing selection on the data by using a feature extraction algorithm to form a feature database;
identifying, from the feature database, a leading associated parameter that produces a reaction beforehand to a change of a critical parameter; and
constructing an equipment prognostic and health management model based on the critical parameter and the leading associated parameter.

7. The method of claim 6, wherein the equipment prognostic and health management model is constructed by using a regression model or an autoregressive integrated moving average model (ARIMA).

8. The method of claim 6, wherein the feature extraction algorithm is at least one selected from a group consisting of a statistical feature, a compound feature and the combination thereof.

9. The method of claim 8, wherein the statistical feature is at least one selected from a group consisting of a maximum value, a minimum value, an average value, a variance, a kurtosis, a skewness, a median value, a range, a mode value, an initial value, an ending value, a data difference level and the combination thereof.

10. The method of claim 8, wherein the compound feature is at least one selected from a principal component analysis (PCA), an independent component analysis (ICA), a neural network (NN) and the combination thereof.
